(19) United States
(12) Patent Application Publication
(10) Pub. No.: US 2009/0124865 A1
(43) Pub. Date: May 14, 2009

(54) System and methods for stress release and associated nitric oxide release for treatment of pain in specific parts of the body

(76) Inventor: James E. Kiernan, Rockaway Park, NY (US)

Correspondence Address: Rashida A. Karmali, JD PhD, 10th Floor, 99 Wall Street, New York, NY, 10005, US

(21) Appl. No.: 11/985,117

(22) Filed: Nov. 14, 2007

(51) Int. Cl. A61H 99/00

(52) U.S. Cl. 600/300; 601/1

(57) ABSTRACT

This invention provides unique technology, systems and methods of treatment of stress induced afflictions in the musculoskeletal system, the vascular system or the nervous tissue. More specifically, the systems comprise diagnosis of a stress-induced consistent tightness on the right side of the cranial, cervical, thoracic, lumbar, sacral spine, referred herein as “The Twist”, and utilize “Stress Relief Methods” to reduce The Twist to resolve any afflictions associated with it. The invention comprises a coordinated series of untwisting dynamic motions, spinal manipulation and/or motion palpations that result in release of nitric oxide and relief from pain. The systems and methods of the invention therefore provide the benefits of increased nitric oxide release to maintain homeostasis in pulmonary vasculature. The invention also provides methods of training others in the correct use of the Stress Relief Methods to prevent and treat afflictions associated with the Twist.

### FIELD OF THE INVENTION

This invention provides unique Stress Release Methods (SRM) NitricOxide releasing technique for prevention and treatment of stress induced afflictions in the musculoskeletal system, the vascular system or the nervous tissue. More specifically, the systems according to the invention comprise diagnosis of a stress-induced consistent tightness on the right side of the thoracic spine, referred herein as “The Twist”, and utilize “Stress Relief Methods” to reduce The Twist and prevent or resolve any afflictions associated with The Twist. The invention comprises a coordinated series of specific untwisting dynamic motions, spinal manipulation and/or motion palpations that result in release of nitric oxide and relief from pain. The systems and methods of the invention therefore provide the benefits of increased nitric oxide release to maintain homeostasis in the cardio pulmonary vasculature and subsequent

Neuromuscularskeletal (NM) system. The invention also provides methods of training others in the use of the systems and techniques for utilizing the “Stress Relief Methods” to reduce the Twist in the cranial, cervical, thoracic, lumbar, sacral spine and to prevent afflictions associated with the Twist.

### BACKGROUND TO THE INVENTION

The Stress Relief Methods (SRM) of the invention comprise unique techniques of treatment of symptoms of undue or unrelieved stress, including release of nitric oxide and profound relaxation and treatment of pain. Stress is a normal physiological response of the body to a hostile environment and symptoms of stress are manifestations of this response. The body tries to overcome stress by certain physiological adjustments. If the body succeeds, then after sometime the physiological adjustments and the stress symptoms revert back to normal. If it fails the physiological adjustments and the stress symptoms persists. It is this persistence of the response that matters. The affected person may develop physical, physiological or psychological problems and may not be able to lead a normal life.

Stress in work place if not managed properly will definitely cause harm both to employer and employee. Job stress has become a common and costly problem in the American workplace, leaving few workers untouched. According to one study, 40% of the American employees feel that their job is very stressful. As the issue of job and related factors causing stress is a persistent one, workplace stress needs to be dealt in a proper way. Otherwise there are chances of stress becoming a chronic problem. Moreover stress impairs the job activities and also causes physical problems like head ache, back ache and later on heart problems. Work related stress results in decreased productivity, increased management problems and increased incidence of illnesses among employees. Stress related problems are the most common causes of sickness absenteeism all over the world. The cost of stress related problems is to the tune of about 150 billion dollars according to a study conducted in US.

Unlike stress in general, the work related stress affects men and women equally. Older employees are affected more than their younger counterparts. Stress at workplace could be due to several factors, for example, external cause like dangerous working condition or poor interpersonal relationship with the colleague, internal causes like physical or psychological illnesses in the long run the stress becomes chronic problem causing serious health problems.

Physiology of Stress—When a person is exposed to a ‘dangerous’ situation his body gets ready to face it. It needs more energy for that. The extra energy is got by the ‘Fight or Flight’ response. The initial step is taken by the hypothalamus of the brain which secretes adrenocorticotrophic releasing hormone (ARH). ARH stimulates the adjacent pituitary gland to secrete adrenocorticotrophic hormone (ACTH). This in turn stimulates the adrenal glands which are situated on the kidneys to secrete Adrenaline and Cortisol. Now these two hormones work together to see that the body gets more energy by providing more oxygen and glucose. For these things to occur, the following adjustments are done: i) Diversion of the blood from less vital to more vital organs, ii) Increase in the heart rate to supply more blood quickly, iii) Increase in the blood pressure to supply blood efficiently, iv) Increase in the respiratory rate to get more oxygen from the atmosphere, v) Breakdown of glycogen stores in liver and muscle to get more glucose, vi) formation of more glucose from non carbohydrate substances.

So at the end of the response, the body is well geared up and it tackles the situation. To put it in a nut shell—The mind feels the danger and the body tackles it. These actions are coordinated by hormones. Once the trigger is gone the hormonal levels drops and the body returns to normal. But if this happens repeatedly, then all the hormonal levels are persistently high not allowing the body to come back to normal The body keeps experiencing the above mentioned ‘adjustments’. Soon the hormonal and energy stores get exhausted. The vital link between the mind and the body is lost and the person suffers. The mind gets disturbed by the fact that the threat is there. But the body is too tired to handle it. The coordination between the two is disturbed.

Stress can affect anyone from children to adolescents to adults. Women are affected twice more than men. Studies show that stress is responsible for 70% visits to doctors and is the reason for 85% of the serious illnesses. Stress if not relieved, may change the person's life from good to bad, bad to worse, worse to worst. If stress is in the house, it will affect the relationship with spouse and other family members. If it is in the educational institution, it will affect the studies. If it is in the work place, it will affect the performance. So stress, no matter what age group it affects, no matter where it affects, should be tackled, so that the person can lead a normal and productive life.

Stress tests are done to find the capability of a person to handle different stressful conditions and their short and long term effects. Some tests involve the assessment of an individual's susceptibility to physical stress while some other assesses the susceptibility to mental stress and its impact. Stress tests are tests done to assess the capability of a person to handle different stressful conditions and their short and long term effects. The nuclear stress test is the most popular among the different stress tests available. Though most of the available stress tests involve the assessment of an individual's susceptibility to physical stress involving mainly the heart, there are other tests also to assess the susceptibility to mental stress and its impact, for example, the physical stress tests, exercise stress tests or the barium meal series.

Physical stress tests are more scientific than their mental counterparts. The most sought after tests are that done for the heart. Some of the physical effects which can be assessed by various tests are Increased heart rate, Increased blood pressure, Increased bowel movements or Increased acidity. Increased heart rate, blood pressure and their effects on heart are assessed by making the person experience a simulator stress like walking on a treadmill.

The other three can be assessed in persons who experience long term stress effects. The different tests used are Nuclear stress test & Exercise stress test—to assess the effect of increased heart rate and blood pressure on heart; Barium meal series—to assess the movement of the bowel; or Bernstein's pH monitoring and Esophagio gastro duodenoscopy—to study about the acidity.

More and more people are subject to stress in the present day because of several reasons. It is very important for such people to handle stress properly, various stress reduction techniques will help them to reduce their stress. Various stress reduction techniques are practiced to reduce stress. Some of the very old principles which were forgotten for years are being revived and followed. Some of the popular and useful stress relief techniques are Yoga, Meditation, Aromatherapy, Hydrotherapy, Deep breathing, Biofeedback, Progressive muscle relaxation, Music Therapy.

U.S. Pat. Nos. 6,090,045 and 6,283,916 and 6,283,916 describe an Expert System Soft tissue motion technique for release of adhesions and associated apparatus for facilitating specific treatment modalities. Specifically, the method is for non-surgical treatment of soft tissue lesions. It includes placing a contact point near the lesion and causing the patient to move in a manner that produces a longitudinal sliding motion of soft tissues, for example, nerves, ligaments, and muscles beneath the contact point. The treatment regimens are continued at sequential time intervals until the symptoms produced by the lesions are alleviated. Conventional treatment for soft tissue lesions involves a sequential protocol, namely, history, evaluation diagnosis and treatment. This conventional method has been criticized in the treatment of soft tissue disorders because the evaluation is flawed due to the level of expertise in the medical profession. U.S. Pat. No. 5,501,657 also describes soft tissue manipulation, deep tissue and nerve entrapment manipulation generally in the forearm and hand to treat medical carpal tunnel syndrome, but it does not affect all of the nerves.

The prior art described above does not in any way address the symptoms associated with the tightness of the cranial, cervical, thoracic, lumbar, sacral spine, especially localized on the right side, and referred to herein as “The Twist”. This Twist appears in patients who are under significant stress, conscious or unconscious and the severity of the Twist is proportional to the degree of stress. The invention provides unique systems and methods of treatment of stress induced afflictions in the musculoskeletal system, the vascular system or the nervous system by using Stress Relief Methods that reduce the Twist by a coordinated series of untwisting dynamic motions, spinal manipulation and motion palpations that result in relief from pain.

None of the stress tests currently in use and described in prior art includes a measure of nitric oxide in exhaled air produced by the people being treated for stress related afflictions and stress management. The invention also provides a system to measure nitric oxide in the exhaled air to indicate the level and severity of the stress and to follow the progress made by treatment using the Stress Relief Methods of the invention.

### SUMMARY OF THE INVENTION

This invention provides unique technology, systems and methods of treatment of stress induced afflictions in the musculoskeletal system, the vascular system or the nervous tissue.

More specifically, the systems according to the invention comprise diagnosis of a stress-induced consistent tightness on the right side of the cranial, cervical, thoracic, lumbar, sacral spine and lengthening on the left spine, referred herein as “The Twist” which is proportional to the severity of the stress.

The present invention is directed to utilizing the “Stress Relief Methods” to reduce the Twist in the cranial, cervical, thoracic, lumbar, sacral spine and to resolve any afflictions associated with the Twist. The invention comprises a coordinated series of untwisting dynamic motions, spinal manipulation and/or motion palpations that result in release of nitric oxide and relief from pain.

The system for the invention measures nitric oxide in the exhaled air by the patients and establishes a physical measure of the severity of the stress and changes in the nitric oxide levels throughout the treatment regimen.

The present invention is directed to utilizing the “Stress Relief Methods” to reduce the Twist in the cranial, cervical, thoracic, lumbar, sacral spine and to prevent afflictions associated with the Twist. The invention comprises a coordinated series of untwisting dynamic motions, spinal manipulation and/or motion palpations that result in release of nitric oxide and relief from pain.

The systems and methods of the invention therefore provide the benefits of increased nitric oxide release to maintain homeostasis in pulmonary vasculature, to treat cardiopulmonary, NMS disorders associated with hypertension, hypoxaemia, inflammation or odema.

The systems and methods of the invention provide techniques of SRM especially suited for seniors and older patients, and for obese patients.

The systems and methods of the invention provide the techniques for upper thoracic movement involving mobilization of Thoracic vertebrae from about T1 through T4. Technique#1 (FIGS. 1 & 2)

The systems and methods of the invention also provide the techniques for the lumbar-thoracic movement involving mobilization of thoracic vertebrae from about L5 to T5. Technique#2 (FIGS. 3, 4 & 5)

The systems and methods of the invention further provide the techniques for an anterior-posterior (A-P) lumbar—Pelvic Movement to stretch the anterior wall of the lumbar and pelvis, posteriorly. Technique#3 (FIGS. 6 & 7)

The systems and methods of the invention provide the techniques for a A-P lumbar thoracic movement to stretch the multifidii in the lumbar spine. Technique #4 (FIGS. 8, 9 & 10)

The systems and methods of the invention provide the techniques for P-A Iliac sacral movement. Let's call this Technique #5 (FIGS. 11 & 12)

The systems and methods of the invention provide the techniques for a cranial-thoracic movement to stretch the trapezius and stemocleidomastoid to induce patient relaxation and de-twisting effect in the Twist. Technique#6 (FIGS. 13, 14 & 15)

The invention provides methods of training others in the use of the systems and techniques of the invention for utilizing the “Stress Relief Methods” to reduce the Twist in the thoracic spine and to prevent afflictions associated with the Twist.

### BRIEF DESCRIPTION OF THE FIGURES

The advantages and features of the present invention will become readily apparent after reading the following detailed description and referencing the drawings. In order to facilitate a fuller understanding of the present invention, photos of patient-practitioner are taken for each session to establish a baseline and to map out the extent of the Twist to establish the medical history. Figures have been drawn from the photos to enable a detailed and consistent analysis of each technique and procedure. Reference is made of the drawings which should not be construed as limiting the present invention, but are intended to be exemplary only and, which are:

FIG. 1 describes in Technique #1 for Upper Thoracic Movement, the position of the Practitioner relative to patient. Camera angle back.

FIG. 2 describes in Technique #1 for Upper Thoracic Movement the Contact Area of thumbs of the Practitioner on the patient. Camera angle close-up.

FIG. 3 describes in Technique #2 for the Lumbar-Thoracic Movement the position of the Practitioner relative to the patient. Camera angle back.

FIG. 4. describes in Technique #2 for the Lumbar-Thoracic Movement the Contact Area of thumbs on patient. Camera angle close-up.

FIG. 5 describes in Technique #2 for the Lumbar-Thoracic Movement the Practitioner “hooking” the patient's extended thigh and showing the practitioner's foot under the table edge. Camera mid-range.

FIG. 6 describes in Technique #3 for the Lumbar-Pelvic Movement, the Practitioner Position relative to patient, in between patient's legs. This also shows practitioner's knee on table and foot hooked over patient's leg. Perhaps a second view is helpful, showing the angle revealing the patient's leg resting on the practioner's thigh. Camera angles back.

FIG. 7 describes in Technique #3 for the Lumbar-Pelvic Movement the Contact Area of the Practitioner's hands on patient. In a shirtless patient the Innominate bone contact is shown. Camera angle close-up.

FIG. 8 describes in Technique #4 for the Lumbar-Pelvic Movement the Finish position of push move. Camera angle back.

FIG. 9 describes in Technique #4 for the Anterior-Posterior Lumbar-Thoracic Movement, the Contact Area of Practitioner's hands on patient. Use a shirtless patient to show sternum and shoulder contacts. Camera angle mid-range.

FIG. 10 describes in Technique #4 for the Anterior-Posterior Lumbar-Thoracic Movement, the Practitioner Position relative to patient. This also shows practitioner's leg placed over patient's displaced thigh. Camera angle back.

FIG. 11 describes in Technique #5 for Posterior to Anterior Sacral-Iliac Movement Camera angle back . . .

FIG. 12 describes in Technique #5 for the Anterior-Posterior Lumbar-Thoracic Movement, showing Finish position of push move. Camera angle back.

FIG. 13 describes in Technique #6 for the Cranial-Thoracic Movement, the Cranial-Thoracic Movement the Practitioner Position relative to patient. Camera angle back/above.

FIG. 14 describes in Technique #6 for the Cranial-Thoracic Movement, the Contact Area of the Practitioner's hands on patient.

FIG. 15 describes in Technique #6 for the Cranial-Thoracic Movement, the Finish position of push move. Camera angle back.

### DETAILED DESCRIPTION OF THE INVENTION

This invention provides unique technology, systems and methods of treatment of stress induced afflictions in the musculoskeletal system, the vascular system or the nervous tissue. More specifically, the systems according to the invention comprise diagnosis of a stress-induced consistent tightness on the right side of the cranial, cervical, thoracic, lumbar, sacral spine, referred herein as “The Twist”, and utilize “Stress Relief Methods” to reduce The Twist and resolve any afflictions associated with The Twist. The invention comprises a coordinated series of untwisting dynamic motions, spinal manipulation and/or motion palpations that result in release of nitric oxide and relief from pain.

### Stress Relief Method (Srm), a Nitric Oxide Release Technique, the “Twist”

The inventor, a professional graduate of Chiropractics, with twenty years of professional experience became increasingly aware of a consistent tightness on the right side of the thoracic spine that was never present on the left side when testing patients. This tightness was also evident in the cranial, cervical, lumbar and sacral areas, He called this phenomenon “The Twist”. He later went on to describe three diagnostic markers for identifying the “Twist”
1. The patient is seated with the doctor standing directly behind the patient. The using his right hand fingers to the right thumb to the left gently extends the cervical spine of the patient, note left vs right side. The right musculature will be shorter and the left lengthend.
2. The patient is seated with the doctor directly behind the patient. This time the doctor grabs the patient's right and left shoulder with the intention of moving the thoracic cage posteriorly, first the right then the left, and compare.
3. The patient lies supine on a flat surface. The doctor stands at the foot of the table lifts the patients legs, one leg in his right hand the other in the left. The doctor allows one leg to rotate inward and compares this to rotation off the other leg. The rotation is subtle with the movement being felt at the hip.

The Twist as defined and described herein, appears in patients who were under significant stress, its severity proportional to the degree of stress. This means that the body has a tendency to contract on the right side and lengthen on the left, regardless of handedness, as a result of nothing more than mental stress. When The Twist worsens, the patient begins to experience pain in different parts of the body with or without an accompanying injury.

Older patients manifest the Twist and any resulting or associated pain the same as younger ones. What differs between them is that most seniors have a greater degree of muscle and bone degeneration, which is an inevitable, intrinsic, physical stressor. Ironically, seniors and obese individuals do not necessarily experience greater pain. This is because they adjust by reducing their activity to accommodate their weaker recovery systems. However, seniors do have a greater chance of incurring an injury if they exceed their accommodation. That is, they have less margin of error. Additionally, the senior recovers from stress more slowly, and recovery must match stress (in all age groups) or injury results. Ironically, this same margin of error and ease of Twist susceptibility makes it easier to relieve pain in the senior. Note, many chiropractors avoid treating seniors because they fear their manipulations may injure their brittle bones and atrophied muscles.

The present invention has standardized the Stress Release Method to be used in older patients and provides relief and relaxation therapy to them.

Factors causing the Twist—The stress pattern begins with nervous tissue (the autonomic nervous system) failing to signal properly to the vascular system and the somatic muscle system. This causes a constriction of blood vessels and tightening of the muscles. This constant stiffness leads to tightness in the muscles and impingement of the nerves. Eventually, the altered structure of the body leads to joint problems. The present invention allows the planning of a patient's treatment by direct the Stress Relief Method towards resolving all these afflictions, through fundamentally reducing The Twist. Instead of treating a patient's back, knee, and leg separately, the practitioner can treat the patient's body and associated problems, as a single unit afflicted by the Twist. Afterwards, by using additional techniques such as Active Release Technique, spinal and motion manipulations the practitioner can address any additional restrictions that may remain.

### The Anatomy of Stress: “the Twist”

The Twist is the physical manifestation of stress, often so present that it is ignored-until it produces pain. It is an indispensable biomarker in understanding both pain and faulty movement patterns (biomechanics). The Twist can affect all movements of the body from the cervical spine to the feet. The Twist reflects and imbalance in the autonomic nervous system caused by an abundance of chemical stress (like coffee, alcohol, drugs), mental stress (like work or family issues) or physical stress (like repetitive movements). The Twist is ingrained and conditioned when these stressors are not followed by a recovery period. While, there are different types of stress, mental stress is probably the final destination of all stressors.

The present inventions allows the prevention of stress related afflictions—physical, vascular, neurological—by treating the Twist before the afflications are manifested. To a skilled SRM practitioner observing a patient, The Twist is apparent before the onset of pain. The Twist is a definite, observable, physical pattern that manifests itself in the same way in all patients affected by it. {see diagnostic markers)} The pattern begins as muscular contractures on only the right side of the body. It occurs on the right side in everyone: men; women; lefties and righties. This means when the practitioner compares the right side Thoracic transvertebral muscles (multifidii, rotators} they will be shorter than the left side. The result is a systematic tightening of the structures on the right, in this case the thoracic vertebrae and ribs. This is because the Thoracic spine because it is key only for its ability to effect the lumbar and cervical spine. The Twist affects the Thoracic spine equally from the cervical to the lumbar. But because of the stabilizing effect of the ribs, pain is typically felt in the cervical or lumbar areas, and not the thoracic. However, work performed on the thoracic spine can be used to relieve symptoms in the cervical or lumbar areas. This relationship between areas is a critical concept within the Stress Relief Method. For example, a patient has pain in the cervical or lumbar spine. Perform the untwisting on the Thoracic spine first. This should cause a reduction of symptoms.

The invention includes techniques that release multiple muscular fixations in the sequence of untwisting is the moved called occipital-thoracic or cranial-thracic movement. This stretching movement is directed at the triangular shaped trapezius muscle. The stretch can be applied in different directions to effect various insertions of the trapezius into the spine.

The invention also includes diagnosis of the Twist seen as the difference between the right transvertebral muscles {multifidii, rotators} i versus the left transvertebral muscles in the thoracic and lumbar spine. The right were always tighter than the left. Similarly, in the cervical spine, the right musculature were always tighter than the left. Two of the moves are directed at Thoracic and Lumbar muscular fixations—one from the anterior the (Anterior thoraco-lumbar) and one from the posterior (posterior-ant thoraco-lumbar It is important to take time with the release of these moves and is not unusual for the patient to get a burning feeling in the Thoracic spine during or following the release. The Twist is pervasive, and its effects can be observed from the occiput down to the foot. It is a “road map” describing the effects of stress on the patient. The greater the stress, the tighter the stress pattern. In most cases, this gross pattern must be addressed before treating isolated areas that remain affected.

So what exactly is The Twist pattern, and how does it begin-how does it afflict the patient? The pattern is a global tightening of the right side of the body. The muscles on the right side contract, the ones on the left lengthen. This can be palpated passively but more important is the pattern demonstrated with dynamic motions. I believe The Twist is responsible for most aberrant mechanics from shoulder problems to ankle problems. These patterns are addressed in the section of this manual describing the Techniques proper.

In summary, the present invention provides systems and methods for application of the Stress Relief Method (SRM), nitric oxide release and a morphine release technique.

Nitric Oxide Release: More specifically, nitric oxide was detected in the exhaled air of the patients, and measured. Unexpectedly, a correlation between the relaxed state with nitric oxide levels was observed. Nitric oxide decreases with stress. So there are two factors to consider. The first is that nitric oxide (NO) decreases with stress and pain, and the second is that pain lessens by reducing the pattern. The pain level of patients was assessed through their reportage, using a scale of 1-10. (1 being the least pain and 10 the worst.). Then, the patients were tested with the breathNO lyzer before and after the untwisting of the pattern. The results demonstrated that patient going through the untwisting process experienced reduced pain and also increased exhaled nitric oxide. In general, the optimum level of NO is around 20-25 ppb. With most patients the levels significantly went from low to high after undergoing treatment. This technique emphasizes first the pattern created by acute/chronic stress from higher centers through limbic areas to sympathetic controlled vasculature. The end result is shorter, tighter muscles (muscular fixations and joint fixations). The treatment is first directed to the primary pattern and then any secondary compensations. By treating the pattern first, many of the secondary compensations disappear or become easier to treat. In other words, the untwisting is returning the body to a less-resistive state. Nitric oxide is the pathway to this relax state, without which the body stays contracted and in The Twist. This is not a stand-alone technique. Once the body has remained in The Twist for a period of time, adaptations occur in muscles and joints that require skills in treating both.

Nitric oxide has been shown to be an important messenger in many vertebrate signal transduction processes. This free radical gas is produced endogenously from arginine. NO has been found to be the endothelium derived factor that produces relaxation of the vascular smooth muscle. Clinical studies of NO in persistent pulmonary hypertension of the newborn are in progress. South Med J, 1995, 88: 33-41. Therefore, the changes in NO observed with the untwisting of the Twist to less-resistive state observed in the present invention may be potential useful in other conditions where NO has used in therapy to improve vascular tone. The systems and methods of the invention therefore provide the benefits of increased nitric oxide release to maintain homeostasis in pulmonary vasculature, to treat cardiopulmonary disorders associated with hypertension, hypoxemia, inflammation or edema.

Specifically, the present invention includes training in six techniques, comprising: 1) Technique #1: Upper-Thoracic Movement; 2) Technique #2: Lumbar-Thoracic Movement; 3) Technique #3: A-P Lumbar-Pelvic Movement; 4) Technique #4: A-P Lumbar-Thoracic Movement; or 5) Technique #5: P-A Sacral-Iliac 6) Cranial-Thoracic Movement.

### Technique #1

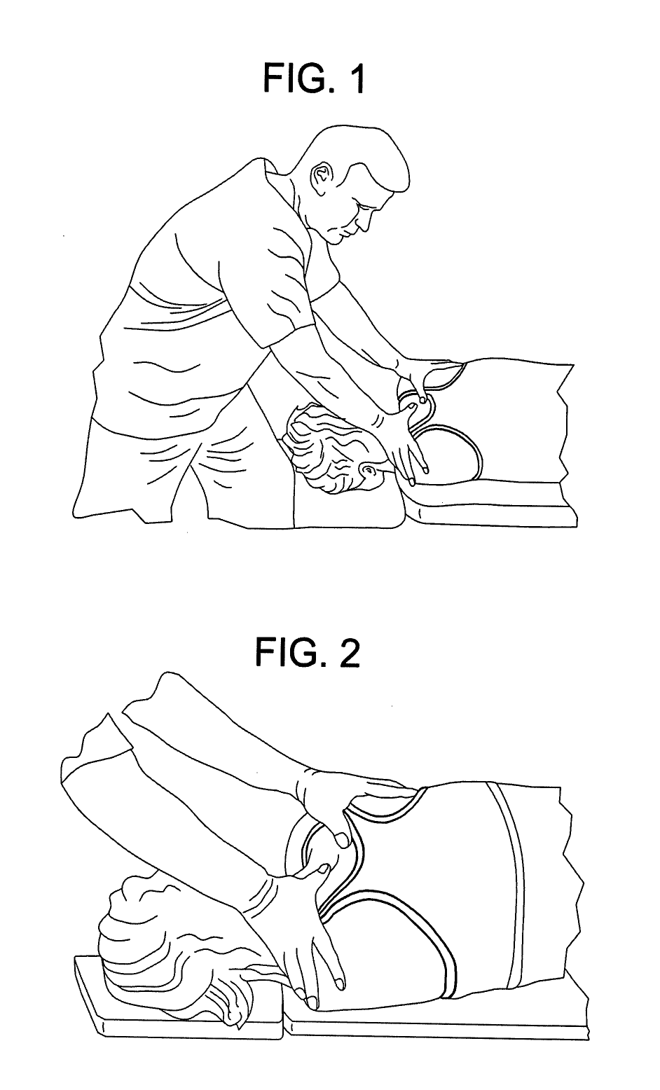

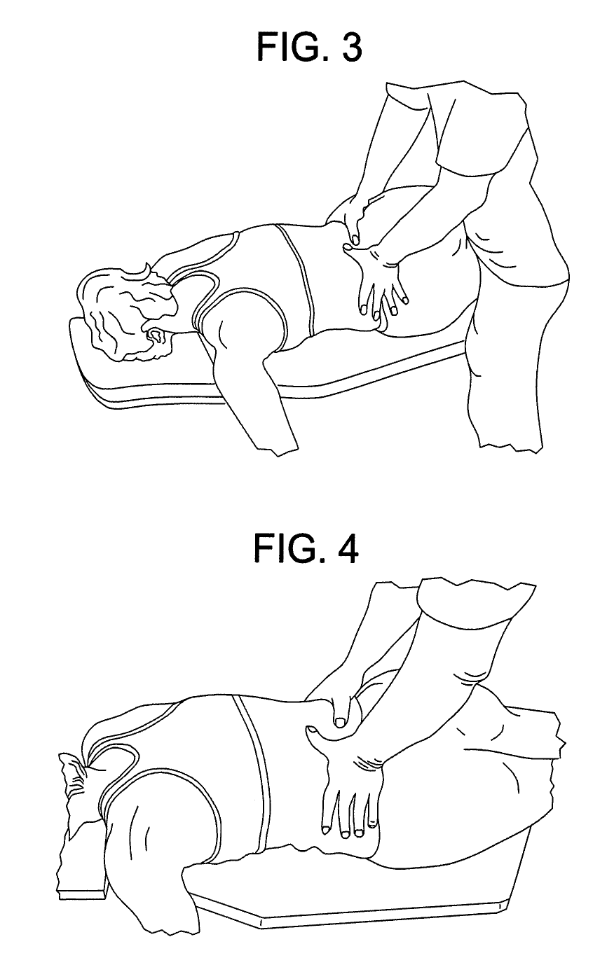

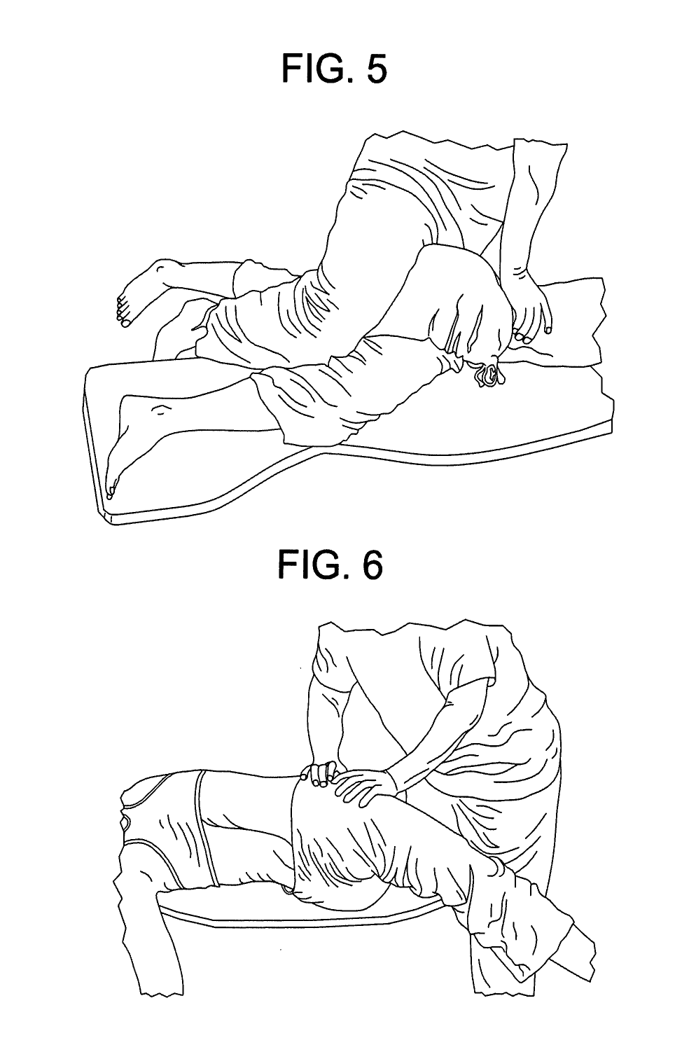

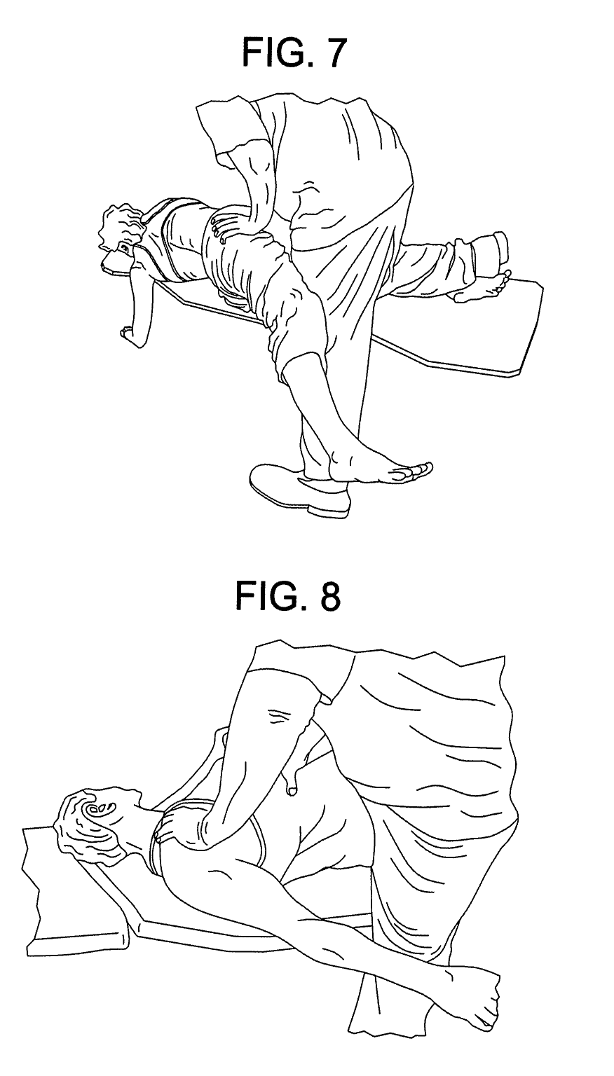

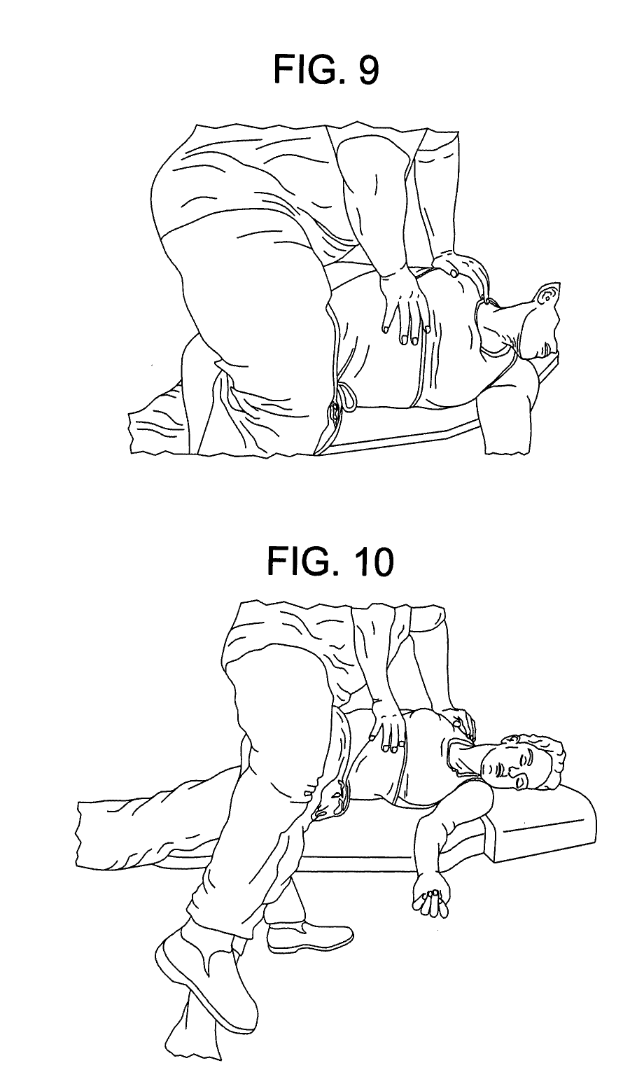

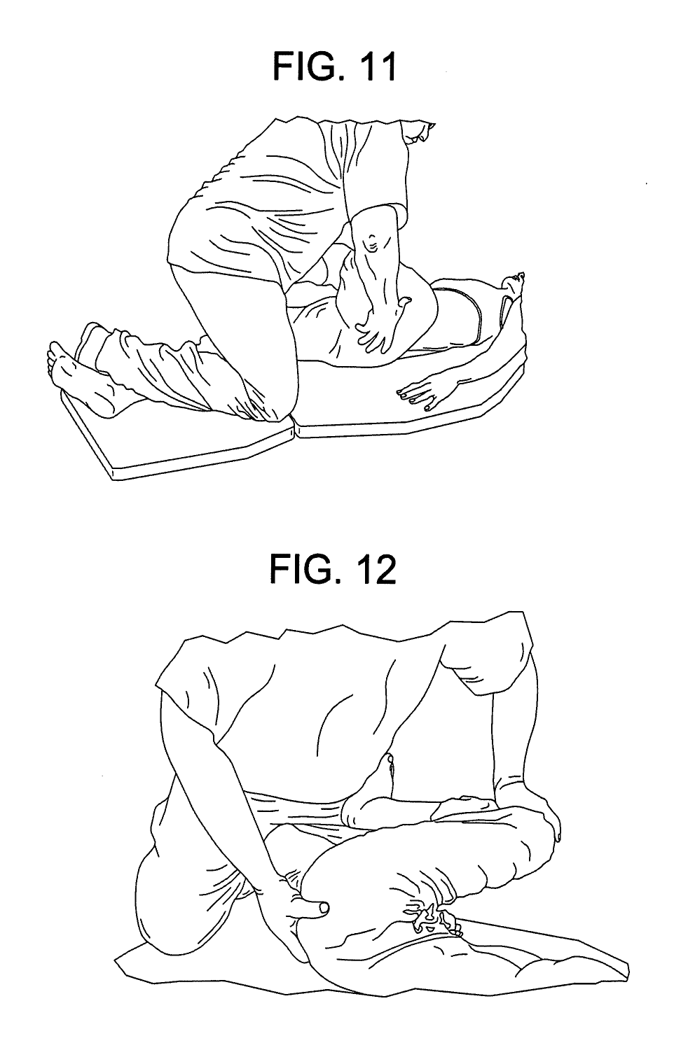

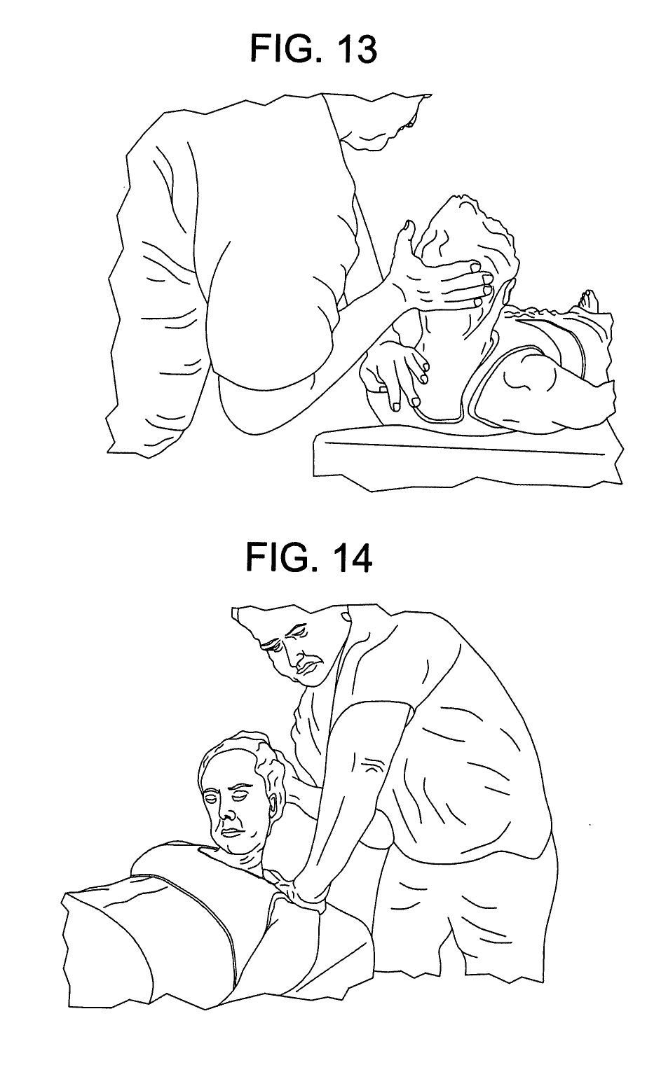

### Upper-Thoracic Movement FIGS. 1, & 2

Objective: Mobilization of spinal joints from T-1 to T-4.

### Patient Position

The patient lies on his left side with the legs straight. The left arm is straight, alongside the body, and on the table. The patient's right arm is adducted across the chest, and hangs off the table. This leaves the right scapula in the protracted position.

### Head Pillow: Yes.

### Practitioner Position

The practitioner stands at the head of the table facing the patient's head. Set the table height so the practitioner's mid-thigh is level with the top of the patient's head.

### Technique

1. The practitioner places his right thumb in flat contact on the right side of the spinous process of T-1. He places his left thumb on the transverse process of the vertebra one or two segments below this area.
2. The practitioner holds this contact with his right thumb and uses his left thumb to push, creating torque at the level of T-1 and T-2. The focus of this push is directed mainly through the left thumb.
3. The practitioner repeats the relative contacts and pushing movement described above, continuing inferiorly down the spine—one joint at a time—to T-4. At each joint, while holding the superior spinous process, the push on the inferior vertebra creates the torque. The practitioner may need to adjust his position behind the patient as he moves down the spine.
Duration: Each push is held for two seconds. Allow the patient time to relax and “sink” into this position.
Patient Breathing: Breathing must be continuous—no breath holding.
Advanced Move This is used for difficult cases at T-1 to T-3. Here, the practitioner's left hand (with the thumb force as the focus) holds the contact, as noted above. His right hand, focusing through the right thumb, pushes deeply at the spinous superior spinous process with the thumb angled inferior and parallel with the spine.

### Technique #2

### Lumbar-Thoracic Movement FIGS. 3, 4 & 5

Objective: Mobilization of spinal joints from L-5 to T-5.

### Patient Position

The patient lies on his left side. The left arm is positioned up and behind him, with the forearm placed on the left arm rest of the table. The patient's right leg is straight and extended back, so that the legs are in a “scissors” position.
Head Pillow: No. The patient places his face into the table headrest.

### Practitioner Position

Set the table height for practitioner comfort (lower, rather than higher). The practitioner stands behind the patient, facing the patient's posterior pelvis.

### Technique

1. The practitioner lifts his right leg and places it over the extended right thigh of the patient, the contact point being just above the patient's knee. Using his right leg, the practitioner extends the patient's right thigh posterior; he hooks the top of his foot under the edge of the table (or, if long limbed, his right foot dangles towards the floor and his shin rests along the table edge). This secures the patient's right thigh in a posterior position, creating posterior torque.
The practitioner is now facing the head of the table with his right knee flexed and between the patient's right and left thigh.
2. The practitioner places his left thumb on the left side of the spinous process of L5. The practitioner places his right hand in flat contact on the posterior side of the patient's right pelvis at the posterior superior iliac spine.
3. The practitioner holds this contact on the superior spinous process with his left hand and uses his right hand to push, creating torque by pushing the pelvis forward. The focus of this push is directed mainly through the practitioner's right thumb, which is positioned inferior and lateral to the spinous process (and the left thumb).
Duration: Each push is held for two seconds. Allow the patient time to relax and “sink” into this position.
4. The practitioner repeats the relative contacts and pushing movement described above, continuing superiorly up the spine-one joint at a time—to T-5. At each joint, while holding the superior spinous process, the push on the inferior vertebra creates the torque. The practitioner may need to adjust his position behind the patient as he moves up the spine.
Patient Breathing: Breathing must be continuous—no breath holding.
Advanced Move Once this basic technique is mastered, the practitioner may coordinate the pushing move of his right hand with a pulling move, extending inferiorly, of his right leg (which has secured the patient's right thigh). This coordinated movement creates even greater posterior torque.
Repeat Techniques #1 and #2: The patient switches position on the table and the practitioner performs the exact techniques on the patient's other side, switching his position (and relative contact points) to do so. First, he performs Technique #1 and then #2.

### Technique #3

### A-P Lumbar-Pelvic Movement FIGS. 6 & 7

Objective: To stretch the anterior wall of the lumbar and pelvis, posterior.

### Patient Position

The patient remains in position from Technique #2. His right hand grabs the near-side armrest—and holds firmly. Also see “Assistant”, below.

### Head Pillow: Yes.

### Practitioner Position

The table height remains in position from Technique #2.
The practitioner stands in between the patient's legs, facing the anterior side of the pelvis. This is a tight fit and usually requires the practitioner to move the patient's right thigh posterior. He places his right knee on the table and with his right foot hooked over the left leg of the patient, thus securing the patient's leg. The practitioner is standing on one leg, his left foot remaining in solid contact with the floor.

### Technique

The practitioner places both hands on the anterior side of the pelvis (on the patient's right side). The primary contact on the pelvis is the innominate bone. The patient's left leg should be somewhat straight and resting on the practitioner's left thigh. With both hands, the practitioner lifts and pushes (“rolls”) the anterior pelvis backward. This move is directed to open the lumbar pelvic area.
Duration: Patients vary greatly in their ability to “open up” with this stretch. The force of the push movement must be gradual, and performed with extreme caution. Allow the patient time to relax and “sink” into this position before pushing. Depending on patient flexibility and compliance, the total duration of the push move varies between 30-90 seconds. Once finished, the practitioner places the patient's right leg gently on the table, and the technique is repeated on the other side.
Patient Breathing: Breathing must be continuous—no breath holding.
Assistant: An assistant may be used to help hold the patient in position. The assistant holds the patient's upper back firmly (using a folded towel as a cushion). This prevents the patient from twisting off the table and helps creates posterior torque.
Repeat Technique: The patient switches position on the table and the practitioner performs the exact technique on the patient's other side, switching his position (and relative contact points) to do so. Once finished, place the patient's head gently on the table, and the technique is repeated on the other side.

### Technique #4

### A-P Lumbar-Thoracic Movement FIGS. 8, 9, & 10

Objective To stretch the transvertebral musculature in the lumbar spine.

### Patient Position

The patient lies on his left side with the legs straight. The left arm is straight, alongside the body, and on the table. The patient's right arm is abducted across the chest. The patient moves his right leg superiorly, keeping the leg straight. The displaced leg hangs off the table, forming a 45°-60° angle between it and the straight leg.

### Head Pillow: Yes.

### Practitioner Position

Set the table height for practitioner comfort (lower, rather than higher). The practitioner stands behind the patient, facing the patient's posterior pelvis.

### Technique

1. The practitioner “semi-straddles” the patient; he lifts his right leg and places it over the displaced right thigh of the patient, thus anchoring the patient's pelvis and creating torque.
2. The practitioner then places his left hand on the patient's right shoulder close to the glenohumeral joint, if not on the pectoralis major itself. He places his right hand near the patient's sternum. A folded towel may be used to cushion the contact areas of the practitioner's hands. The practitioner is now facing the head of the table with his right leg over the patient's right thigh. He is standing on one leg, his left foot remaining on the floor.
3. The practitioner pushes the patient's right shoulder and thoracic cage towards the floor. However, the push is primarily through the thoracic cage, to safeguard the shoulder.
Duration: Patients vary greatly in their ability to “open up” with this stretch. The force of the push movement must be gradual, and performed with extreme caution. Allow the patient time to relax and “sink” into this position before pushing. Depending on patient flexibility and compliance, the total duration of the push move varies between 30-90 seconds. Once finished, the practitioner gently returns the patient to his start position.
Patient Breathing: Breathing must be continuous—no breath holding.
Assistant: Rather than having the practitioner straddle the patient, an assistant may be used to help hold the patient in position. Here, the practitioner keeps both his feet on the floor. The assistant holds the patient's right thigh and pelvis (using a folded towel for padding). This prevents the patient's leg from rising. With inflexible patients, allow the patient's right thigh to raise enough before holding it, so that the practitioner can more easily get into his pushing position.
Repeat Technique: The patient switches position on the table and the practitioner performs the exact technique on the patient's other side, switching his position (and relative contact points) to do so.

### Technique #5

### PA Sacral-Iliac Movement FIGS. 11 & 12

Objective To stretch the sacraliliac joint and associate muscularture

### Patient Position

The lies supine on the treatment table, legs and arms straight, in a fully relaxed position.
Head pillow: optional

### Practitioner

The practitioner choosing to treat the right sacraliliac joint, stands on the left side of the table facing headward

### Technique

1. The practitioner begins with flexing the patients right thigh then adducts the thigh while maintaining the flexed thigh. The patients foot comes to rest on the right thigh of the practitioner {for the purpose of creating torque}.
2. The practitioner will place his left knee over the patients extended leg, to give better leverage.
3. The practitioner will use his left hand over the Sacral iliac area and right hand on the patients right thigh. The practitioner left hand exert PA pressure over the sacraliliac area.
4. The practitioner right hand is on the right thigh of the patient flexing and adducting the thigh while maintaining Posterior to anterior pressure at the sacraliliac area.
Patient breathing: continuous breathing is a must, no breath holding
Assistance: The practitioner may benefit by having an assistant guide the knee into flexion and adduction
Repeat Technique: The practioner will repeat the exact procedure on the opposite side.

### Technique #6

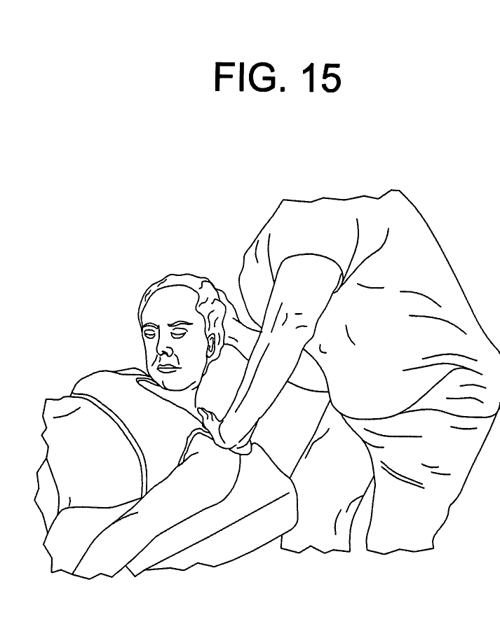

### Cranial-Thoracic Movement FIGS. 13, 14 & 15

Objective To stretch the trapezius (and stemocleidomastoid), which increases patient relaxation and contributes to the de-twisting effect.

### Patient Position

The patient lies supine on the table, legs and arms straight, in a fully relaxed position.

### Head Pillow: No.

### Practitioner Position

The correct table height position is critical. Set the table height for practitioner comfort (lower, rather than higher). The practitioner stands at the head of the table facing the patient's head.

### Technique

1. The practitioner moves slightly to his left. He lifts the patient's head with two hands (gently flexing the patient's neck forward), and then places his right hand at the origin of the trapezius fibers. The hand contact position is the hypothenar area.
The practitioner takes the patient's neck into full flexion, and then gently transfers the head from his two hands to his one contact hand. Once the head is transferred, he braces his right arm by placing his elbow near or on his right hip (or into his abdomen), thus forming a firm “lock” between his body and his hand.
2. The practitioner then places his left hand on the patient's left shoulder to hold it on the table. The holding hand is fully pronated and points posteriorly.
3. Now in the start position of the move, the practitioner gently pushes the patient's head. The direction (angle) of the push is anterior and lateral to his pushing hand. This produces a full stretch of the trapezius muscles. The push is performed by gently leaning the body into the braced elbow (and hand contact) rather than driving the pushing arm forward.
Note that even though there is an angle to the push, the patient's chin should be near the center of suprastemal notch. This is to avoid excessive rotation of the neck. If there is excessive rotation, the practitioner must stop and begin the move from the start.
Technique “Form”: For most practitioners, at the finish point in the pushing movement, their left foot should be forward (along the table's left side) and their right foot back (behind the head of the table); here, they will be in a position that resembles a slightly forward “lunge”. The degree of separation between the feet depends on practitioner limb length and comfort.
Duration: Patients vary greatly in their ability to tolerate this stretch. The force of the push must be gradual, and performed with extreme caution. Depending on patient flexibility and compliance, the total duration of the push varies between 20-45 seconds per side. Once finished, place the patient's head gently on the table. The technique is then repeated on the other side.
Patient Breathing: Breathing must be continuous—no breath holding.
Assistant: Sometimes, the patient's unsupported shoulder will rise excessively. Here, the assistant gently holds the shoulder down.
Repeat Technique: The practitioner switches position on the table and performs the exact technique on the patient's other side, switching his position (and relative contact points) to do so.

### EXAMPLES

The invention provides methods of training others in the use of the systems and techniques of the invention for correctly utilizing the “Stress Relief Methods” to reduce the Twist in the thoracic spine and to prevent afflictions associated with the Twist.

### The Nature of the Twist

In order to determine a diagnosis based on the nature of the Twist, observe the difference between the patient's left and right sides. There is a right (tight) side contraction and a left side laxity. This difference appears in over 95% of the patients. Do not overstretch the patient's left (lax) side. Usually, less force is required in the moves performed on the patient's left side.

Execution: First, create a “storyboard” by using a digital camera and taking the following shots. Sometimes, it will be necessary to take the same shot but from opposite angles. Choose which one is best. Better to take more photos at this easy, inexpensive stage then fewer shots. Then, once satisfied, present the selected angles to a professional photographer. Note: Make sure the table is placed in the center of the room so the photographer can work all shot distances from any angle. In order to create a record for each of the five techniques, specific photo shots have to be taken to record the most relevant and correct movements and procedures used for each technique, as described below.

### Technique #1

### Upper-Thoracic Movement. FIGSs 1 & 2

Overview Photo or Illustration: Show skeletal of area involved (T-1 to T-4)
Photo 1: Patient Position (patient only). Camera angle back.
Photo 2: Practitioner Position (relative to patient). Camera angle back.
Photo 3: Contact Area of thumbs on patient. Camera angle close-up.
Photo 4: Finish position of push move. Camera angle back.
Photo 5: Contact Area of thumbs for Advanced Move. Camera angle close-up.

### Technique #2

### Lumbar-Thoracic Movement FIGSs 3, 4, & 5

Overview Photo or Illustration: Show skeletal of area involved (L-5 to T-5).
Photo 1: Patient Position (patient only). Camera angle back.
Photo 2: Practitioner Position (relative to patient). Camera angle back.
Photo 3: Practitioner “hooking” the patients extended thigh and showing the practitioner's foot under the table edge. Camera mid-range.
Photo 4: Contact Area of thumbs on patient. Camera angle close-up.
Photo 5: Finish position of push move. Camera angle back.

### Technique #3

### A-P Lumbar-Pelvic Movement FIGSs 6 & 7

Overview Photo or Illustration: Show skeletal of area involved (pelvis).
Photo 1: Patient Position (patient only), showing patient grabbing armrest. Camera angle back.
Photo 2: Practitioner Position (relative to patient) in between patient's legs. This also shows practitioner's knee on table and foot hooked over patient's leg. Perhaps a second view is helpful, showing the angle revealing the patient's leg resting on the practioner's thigh. Camera angles back.
Photo 3: Contact Area of hands on patient. Use a shirtless patient to show innominate bone contact. Camera angle close-up.
Photo 4: Finish position of push move. Camera angle back.
Photo 5: show how an Assistant is used to “back-up” the patient while the move is being done.
This shows a completed (finish position) movement but with the assistant in the foreground. Camera angle back.

### Technique #4

### A-P Lumbar-Thoracic Movement FIGSs 8, 9 & 10

Overview Photo or Illustration: Show skeletal of area involved (lumbar spine).
Photo 1: Patient Position (patient only), showing patient grabbing armrest. Camera angle back.
Photo 2: Practitioner Position (relative to patient). This also shows practitioner's leg placed over patient's displaced thigh. Camera angle back.
Photo 3: Contact Area of hands on patient. Use a shirtless patient to show sternum and shoulder contacts. Camera angle mid-range.
Photo 4: Finish position of push move. Camera angle back.
Photo 5: Show how an Assistant is used to hold the patient's thigh and hip while the move is being done. This shows a completed (finish position) movement probably from the head of the table. Camera angle back.

### Technique #5

### PA Sacral-Iliac Movement FIGS. 11 & 12

Overview Photo or Illustration: Show posterior skull.
Photo 1: Patient Position (patient only). Camera angle back/above.
Photo 2: Practitioner Position (relative to patient). Camera angle back/above.
Photo 3: Contact Area of hands on patient.
Photo 4: Finish position of push move

### Technique #6

### Cranial-Thoracic Movement FIGS. 13, 14 & 15

Overview Photo or Illustration: Show posterior skull.
Photo 1: Patient Position (patient only). Camera angle back/above.
Photo 2: Practitioner Position (relative to patient). Camera angle back/above.
Photo 3: Contact Area of hands on patient. Here two photos may be needed. One, lifting the head into flexion; the other, the hypothenar contact area at the start of the move. Camera angles mid-range and close up. Must show the angle of push (trapezius stretch vector)
Photo 4: Finish position of push move. Camera angle back. Try different angles. One from foot of table the other from behind the practitioner. Another angle from the side, showing the relative foot positions of the practitioner is useful.
Photo 5: Show how an Assistant is used to hold the patient's shoulder from rising (while move is being done). Camera mid-angle/above taken from foot of table.

The present invention is not to be limited in scope by the embodiment disclosed in the example which is intended as an illustration of one aspect of the invention and any methods which are functionally equivalent are within the scope of the invention. Indeed, various modifications of the invention in addition to those shown and described herein will become apparent to those skilled in the art from the foregoing description. Such modifications are intended to fall within the scope of the appended claims.

Those skilled in the art will recognize, or be able to ascertain using no more than routine experimentation, any equivalents to the specific embodiments of the invention described herein. Such equivalents are intended to be encompassed by the claims.

What is claimed is:

1. A system for use in the prevention and treatment of stress induced afflictions and pain in individuals, said system comprising:
diagnosis of the stress-induced pain as a tightness on the right side of the individual's thoracic spine, wherein said tightness is referred to as the Twist;
means for recording a plurality of symptoms as images or clinical measurements to establish a baseline profile; and
a plurality of Stress Relief Methods developed to reduce the tightness of the Twist by a coordinated series of untwisting dynamic motions to induce relief from pain.

2. The system according to claim 1 wherein the means of recording symptoms include measurement of clinical parameters including exhale nitric oxide, urine pH, or blood pressure.

3. The system according to claim 1, wherein the Stress Relief Methods include one or more of Techniques selected from the group consisting of Technique #1 for Upper Thoracic Movement, Technique #2 for Lumbar-Thoracic Movement, Technique #3 for Lumbar-Pelvic Movement, Technique #4 for Anterior-Posterior Lumbar-Thoracic Movement, Technique #5: PA Sacral-Iliac Movement or Technique #6 for PA Sacral-Iliac Movement #6 for Cranial-Thoracic Movement.

4. The system according to claim 1 wherein the Stress Relief Methods further comprise spinal manipulations and motion palpitations to induce relief from pain.

5. The system according to claim 3, wherein the measurement of nitric oxide is used to monitor the severity of the Twist in an individual.

6. A system for use in the prevention and treatment of stress induced afflictions and pain in individuals, said system comprising:
diagnosis of the stress-induced pain as a tightness on the right side of the individual's thoracic spine, wherein said tightness is referred to as the Twist;
means for recording a plurality of symptoms as images and measurement of exhaled nitric oxide to establish a baseline profile; and
a plurality of Stress Relief Methods used to reduce the tightness of the Twist and to increase the level of nitric oxide in exhaled air.

7. The system according to claim 7 wherein the symptoms of stress are prevented by regulating the release of nitric oxide in exhaled air by the individual.

8. The system according to claim 8 wherein the release of nitric oxide is induced to regulate cardio pulmonary vascular tone.

9. The system according to claim 7 wherein the Stress Relief Methods include one or more of Techniques selected from the group consisting of Technique #1 for Upper Thoracic Movement, Technique #2 for Lumbar-Thoracic Movement, Technique #3 for Lumbar-Pelvic Movement, Technique #4 for Anterior-Posterior Lumbar-Thoracic Movement, Technique #5: PA Sacral-Iliac Movement or Technique #6 for Cranial-Thoracic Movement.

10. A method of training medical practitioners in use of the Stress Release Methods in the prevention and treatment of stress induced afflictions and pain in individuals, said method comprising the steps of:
training the medical practitioners to diagnose accurately, the stress-induced pain as a tightness on the right side of the individual's cranial, cervical thoracic, lumbar, sacral spine, wherein said tightness is referred to as the Twist;
recording a plurality of symptoms as images or clinical measurements to establish a baseline profile of the medical record; and
training the medical practitioners to use a plurality of Stress Relief Methods developed to reduce the tightness of the Twist by a coordinated series of untwisting dynamic motions to induce relief from pain.

11. The method according to claim 11 wherein the step of recording symptoms further includes measurement of clinical parameters including exhale nitric oxide, urine pH, or blood pressure.

12. The method according to claim 11, wherein the step of training the medical practitioner in Stress Relief Methods include learning how to use one or more of Techniques selected from the group consisting of Technique #1 for Upper Thoracic Movement, Technique #2 for Lumbar-Thoracic Movement, Technique #3 for Lumbar-Pelvic Movement, Technique #4 for Anterior-Posterior Lumbar-Thoracic Movement, Technique #5: PA Sacral-Iliac Movement or Technique #6 for Cranial-Thoracic Movement.

13. The method according to claim 11 wherein the training in the use of the Stress Relief Methods further comprise training in spinal manipulations and motion palpitations to induce relief from pain.

14. The method according to claim 13, wherein the training of the medical practitioners includes learning how to use the measurement of nitric oxide to monitor the severity of the Twist in an individual.

15. A method of training medical practitioners to use Stress Relief Methods in the prevention and treatment of stress induced afflictions and pain in individuals, said method comprising:
diagnosing correctly the stress-induced pain as a tightness on the right side of the individual's thoracic spine, wherein said tightness is referred to as the Twist;
recording a plurality of symptoms as images and measurement of exhaled nitric oxide to establish a baseline profile; and
using a plurality of Stress Relief Methods to reduce the tightness of the Twist and to increase the level of nitric oxide in exhaled air.

16. The method according to claim 17 wherein the medical practitioner is trained to prevent symptoms of stress by regulating the release of nitric oxide in exhaled air by the individual.

17. The method according to claim 18 wherein the medical practitioner is trained to induce release of nitric oxide to regulate cardio pulmonary vascular tone.

18. The method according to claim 17 wherein the medical practitioner is trained in one or more Stress Relief Methods including selected from the group consisting of Technique #1 for Upper Thoracic Movement, Technique #2 for Lumbar-Thoracic Movement, Technique #3 for Lumbar-Pelvic Movement, Technique #4 for Anterior-Posterior Lumbar-Thoracic Movement, Technique #5: PA Sacral-Iliac Movement or Technique #6 for Cranial-Thoracic Movement.
